(19) United States
(12) Patent Application Publication
(10) Pub. No.: US 2025/0370624 A1
(43) Pub. Date: Dec. 4, 2025

(54) APPARATUS AND METHOD FOR REDUCING OR ADJUSTING UNBALANCED PERFORMANCE BASED ON BAD BLOCKS IN A MEMORY DEVICE

(71) Applicant: SK hynix Inc., Gyeonggi-do (KR)

(72) Inventor: Se Joong KIM, Gyeonggi-do (KR)

(21) Appl. No.: 18/904,078

(22) Filed: Oct. 2, 2024

(30) Foreign Application Priority Data
May 28, 2024 (KR) 10-2024-0069548

(51) Int. Cl. G06F 3/06

(52) U.S. Cl. CPC G06F 3/0613; G06F 3/064; G06F 3/0679

(57) ABSTRACT

A memory system includes a memory device comprising plural memory dies, each memory die comprising plural memory blocks and including an active area and an inactive area and a controller configured to adjust sums of a bad block size and an inactive area size in the plural memory dies to be equal to each other based on a bad block occurring or found in the plural memory dies.

### CROSS-REFERENCE TO RELATED APPLICATIONS

This patent application claims the benefit of priority under 35 U.S.C. § 119 (a) to Korean Patent Application No. 10-2024-0069548, filed on May 28, 2024, the entire disclosure of which is incorporated herein by reference.

### TECHNICAL FIELD

One or more embodiments of the present disclosure described herein relate to a memory system, and more particularly, to a device and a method for controlling a memory device including a bad block in a memory system.

### BACKGROUND

A memory system can include a volatile memory or a non-volatile memory. The memory system may include various components for efficiently controlling or operating the volatile memory or non-volatile memory. The memory system may undergo various tests to confirm whether to operate normally after manufacturing. In addition, the memory system may perform a debugging operation during a data input/output operation. The memory system may transmit information corresponding to an event that occurred within the memory system to an outside device. In addition to the data input/output operation, the memory system may perform various operations to efficiently support the data input/output operation. These operations may be performed based on system data.

### BRIEF DESCRIPTION OF THE DRAWINGS

The description herein makes reference to the accompanying drawings wherein like reference numerals refer to like parts throughout the figures.

FIG. 1 illustrates a memory system according to an embodiment of the present disclosure.

FIG. 2 illustrates a memory device according to an embodiment of the present disclosure.

FIG. 3 illustrates a configuration of a memory device according to an embodiment of the present disclosure.

FIG. 4 illustrates a configuration change based on a bad block in a memory die according to an embodiment of the present disclosure.

FIG. 5 illustrates a memory device including a plurality of memory dies.

FIG. 6 illustrates a first control operation performed in a memory system according to an embodiment of the present disclosure.

FIG. 7 illustrates a second control operation performed in a memory system according to an embodiment of the present disclosure.

FIG. 8 illustrates a third control operation performed in a memory system according to an embodiment of the present disclosure.

FIG. 9 illustrates a fourth control operation performed in a memory system according to an embodiment of the present disclosure.

FIG. 10 illustrates a data infrastructure according to an embodiment of the present disclosure.

FIG. 11 illustrates a memory system according to an embodiment of the present disclosure.

FIG. 12 illustrates a memory system according to an embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. Examples of block/unit/circuit/component used with the “configured to” language include hardware, circuits, memory storing program instructions executable to implement the operation, etc. Additionally, “configured to” can include a generic structure, e.g., generic circuitry, that is manipulated by software and/or firmware, e.g., an FPGA or a general-purpose processor executing software to operate in a manner that is capable of performing the task(s) at issue. “Configured to” may also include adapting a manufacturing process, e.g., a semiconductor fabrication facility, to fabricate devices, e.g., integrated circuits that are adapted to implement or perform one or more tasks.

As used in this disclosure, the term ‘machine,’ ‘circuitry’ or ‘logic’ refers to all of the following: (a) hardware-only circuit implementations such as implementations in only analog and/or digital circuitry and (b) combinations of circuits and software and/or firmware, such as (as applicable): (i) to a combination of processor(s) or (ii) to portions of processor(s)/software including digital signal processor(s), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘machine,’ ‘circuitry’ or ‘logic’ applies to all uses of this term in this application, including in any claims. As a further example, as used in this application, the term ‘machine,’ ‘circuitry’ or ‘logic’ also covers an implementation of merely a processor or multiple processors or a portion of a processor and its (or their) accompanying software and/or firmware. The term ‘machine,’ ‘circuitry’ or ‘logic’ also covers, for example, and if applicable to a particular claim element, an integrated circuit for a storage device.

As used herein, the terms ‘first,’ ‘second,’ ‘third,’ and so on are used as labels for nouns that they precede, and do not imply any type of ordering, e.g., spatial, temporal, logical, etc. The terms ‘first’ and ‘second’ do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term ‘based on’ is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

An embodiment of the present disclosure can provide an apparatus and a method capable of improving performance of a memory device and a memory system including the memory device.

An embodiment of the present disclosure can improve data input/output performance in a memory system including multiple memory dies by reducing a difference between performances of the multiple memory dies.

In addition, in a data center or a mass storage device including plural memory systems according to an embodiment of the present disclosure, a performance difference or deviation of the plural memory systems can be reduced, thereby improving an efficiency of controlling and managing data input/output performance of the data center or the mass storage device.

Further, an embodiment of the present disclosure can provide a device and a method for controlling factors affecting performance differences, such as a size of an over provisioning area, a throttling and a ratio of host writes and garbage collection writes, in order to reduce or adjust a difference in performance of random data writes performed in each memory die, which occurs due to different sizes of bad blocks included in plural memory dies in a memory system.

An embodiment of the present disclosure can provide a memory system including a memory device including plural memory dies, each memory die including plural memory blocks including an active area and an inactive area; and a controller configured to adjust sums of a bad block size and an inactive area size in the plural memory dies to be equal to each other based on a bad block occurring or found in the plural memory dies.

The controller can be configured to determine an active area size of a first memory die in response according to a bad block size occurring or found in the first memory die, so that a sum of the inactive area size and the bad block size for the first memory becomes a same as a sum of for another memory die.

The controller can be configured to determine, as the inactive area, at least one cell string among a plurality of cell strings included in each of the plurality of memory dies.

The controller can be configured to determine, as the inactive area, memory cells connected to at least one word line among a plurality of word lines in each of the plurality of memory dies.

The memory device can include an over provisioning area comprising including at least the inactive area and the bad blocks in each of the plurality of memory dies. The controller can be configured determine that sizes of the over provisioning areas in each of the plurality of memory dies are equal to each other.

The controller can be configured to adjust data input/output performance of each of the plurality of memory dies to be equal.

The controller can be configured to determine the data input/output performance based on a random data writing operation performed within on each of the plurality of memory dies.

The controller can be configured to control a throttling level for the first memory die in response according to the second size of the bad block sizes that occurred or found in the first memory die.

The controller can be configured to adjust a ratio of host write operations and garbage collection write operations for the first memory die in response according to the second size of the bad block sizes that occurred or found in the first memory die.

Another embodiment of the present disclosure can provide a memory system including a memory device including a plurality of memory dies, each memory die including a plurality of memory blocks; and a controller configured to adjust, based on a difference in bad block sizes in the plurality of memory dies, at least one of scheduling of data input/output operations, performed in at least one of the plurality of memory dies, and an inactive area size in each of the plurality of memory dies.

When adjusting the scheduling of the data input/output operations, The controller can be configured to adjust at least one of throttling levels for at least one of the plurality of memory dies and a ratio of host write operations and garbage collection write operations performed on at least one of the plurality of memory dies.

The controller can be configured to determine a first memory die including a greatest number of bad blocks among the plurality of memory dies, set the first memory die to include no inactive area; and determine an inactive area size in each of remaining memory dies other than the first memory die among the plurality of memory dies based on a difference in bad block sizes of the first memory die and each of the remaining memory dies.

The controller can be configured to determine, as the inactive area, at least one cell string among a plurality of cell strings in each of the plurality of memory dies.

The controller can be configured to determine, as the inactive area, memory cells coupled to at least one word line among a plurality of word lines in each of the plurality of memory dies.

The controller can be configured to adjust random data write performance of each of the plurality of memory dies to be substantially a same.

Another embodiment of the present disclosure can provide a memory system including a memory device including a plurality of first memory dies and a plurality of second memory dies; and a controller coupled to the plurality of first memory dies through a first channel and coupled to the plurality of second memory dies through a second channel. The controller can be configured to adjust first inactive area sizes in the plurality of first memory dies based on first bad block sizes in the plurality of first memory dies; and adjust second inactive area sizes in the plurality of second memory dies based on second bad block sizes occurring or found in the plurality of second memory dies.

The controller can be configured to determine, as the first inactive areas, at least one cell string among a plurality of cell strings in at least one of the plurality of first memory dies; and determine, as the second inactive area, at least one cell string of a plurality of cell strings in at least one of the plurality of second memory dies.

The controller can be configured to determine, as the first inactive areas, memory cells coupled to at least one word line among a plurality of word lines in at least one of the plurality of first memory dies; and determine, as the second inactive areas, memory cells coupled to at least one word line among a plurality of word lines in at least one of the plurality of second memory dies.

The controller can be further configured to adjust scheduling of data input/output operations performed on the plurality of first memory dies and the plurality of second memory dies, based on a difference between a first sum of the first bad block sizes and the first inactive area sizes in the plurality of first memory dies and a second sum of the second bad block sizes and the second inactive area sizes in the plurality of second memory dies.

The controller can be further configured to adjust the scheduling of the data input/output operations by at least one of: adjusting throttling levels for the plurality of first or second memory dies; and adjusting a ratio of host write operations and garbage collection write operations performed on the plurality of first or second memory dies.

These and other features and advantages of the invention will become apparent from the detailed description and the accompanying drawings of embodiments of the present disclosure. Embodiments will now be described with reference to the accompanying drawings, wherein like numbers reference like elements.

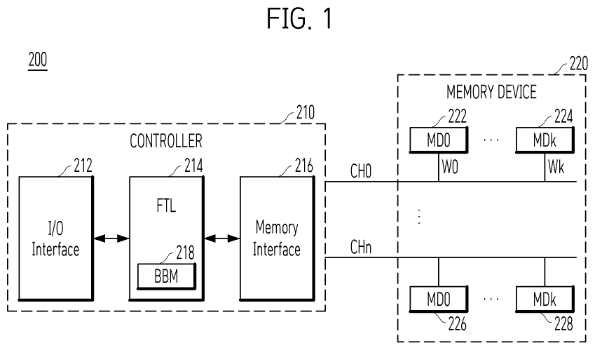

FIG. 1 illustrates a memory system 200 according to an embodiment of the present disclosure.

Referring to FIG. 1, the memory system 200 can include a controller 210 and a memory device 220. Depending on an embodiment, the memory system 200 can be implemented as one of various types of storage devices, such as a solid state drive (SSD), a multimedia card (MMC), an embedded MMC (eMMC), a reduced size MMC (RS-MMC), an MMC in the form of a micro-MMC, a secure digital (SD) card in the form of an SD, mini-SD, or micro-SD, a universal storage bus (USB) storage device, a universal flash storage (UFS) device, a compact flash (CF) card, a smart media (Smart Media) card, or a memory stick.

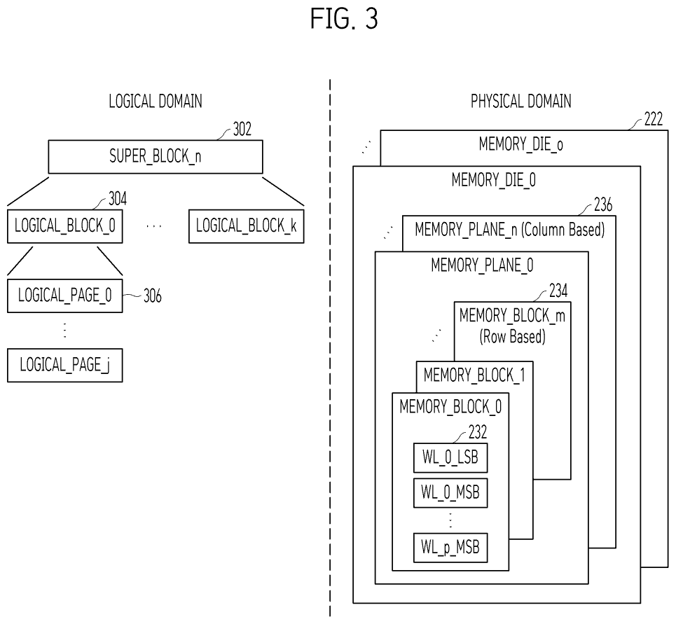

Depending on an embodiment, the controller 210 can include an input/output (I/O) interface 212, a flash translation layer (FTL) 214, and a memory interface 216. The controller 210 can include various components. Depending on performance of the memory system 200 or the controller 210, components within the controller 210 can vary. The memory device 220 can include a plurality of memory dies 222, 224, 226, 228. The plurality of memory dies 222, 224, 226, 228 can include a plurality of data storage areas (e.g., memory blocks, memory pages, memory planes, etc.). The storage areas can be distinguished according to the number of bits of data that can be stored or expressed in a single memory cell. The memory block included in the memory device 220 can include single level cells (SLC), double level cells (DLC), triple level cells (TLC), quadruple level cells (QLC), or multiple level cells constituting a plurality of pages. The memory cells can be designed to store 5 bits or more of bit data in one memory cell. The specific configuration of the memory device 220 will be described later with reference to FIG. 3.

According to an embodiment, the memory device 220 may be implemented as a memory device such as a Read Only Memory (ROM), a Mask ROM (MROM), a Programmable ROM (PROM), an Erasable ROM (EPROM), an Electrically Erasable ROM (EEPROM), a Phase change RAM (PRAM), a Magnetic RAM (MRAM), a NAND or NOR flash memory, a Phase Change Random Access Memory (PCRAM), a Resistive Random Access Memory (RRAM), a Ferroelectric Random Access Memory (FRAM), or a Spin Transfer Torque Magnetic Random Access Memory (STT-MRAM).

The controller 210 can be coupled to the memory device 220 through at least one channel CH0 to CHn and at least one way W0 to Wk. The controller 210 can transmit commands, write data, etc. through the at least one channel CH0 to CHn and the at least one way W0 to Wk, and the memory device 220 can transmit responses, read data, etc. corresponding to the commands through the at least one channel CH0, CHn and the at least one way W0 to Wk. For reference, memory dies MD0 to MDk may correspond to of the respective ways W0 to Wk.

The I/O interface 212 in the controller 210 can receive data or commands transmitted from an external device. In addition, the I/O interface 212 can output data or responses to be transmitted to an external device. The I/O interface 212 can perform data communication through a preset protocol with the external device. There are various interface protocols such as USB (Universal Serial Bus), MMC (Multi-Media Card), PATA (Parallel Advanced Technology Attachment), SCSI (Small Computer System Interface), ESDI (Enhanced Small Disk Interface), IDE (Integrated Drive Electronics), PCIE (Peripheral Component Interconnect Express), SAS (Serial-attached SCSI), SATA (Serial Advanced Technology Attachment), and MIPI (Mobile Industry Processor Interface), which are examples of agreed upon communication standards or interfaces for transmitting and receiving data or commands.

The flash translation layer (FTL) 214 within the controller 210 can control processing and transfer of tasks between components within the controller 210 and manage a mapping between an address used by external devices and an address used by the memory device 220. For example, the flash translation layer (FTL) 214 can manage the mapping between logical addresses and physical addresses, thereby determining a storage location of data entry and performing operations for managing a lifespan of the memory device 220. Depending on an embodiment, the flash translation layer (FTL) 214 can manage events received from the I/O interface 212, manage map data, track and monitor operational status for performing garbage collection or wear leveling, or perform scheduling for commands performed within the memory device 220.

The flash translation layer (FTL) 214 may include a bad block manager (BBM) 218. The bad block manager 218 can determine whether a memory block included in the memory device 220 is available for inputting and outputting data (e.g., whether a memory block is operable). For multiple memory blocks in the memory device 220 after manufacturing, the controller 210 or an external device can test or check whether each memory block stores data and outputs the stored data. For example, if a defect is found in a memory block during the manufacturing process, the memory block can be determined as a bad block that cannot be used (e.g., inoperable).

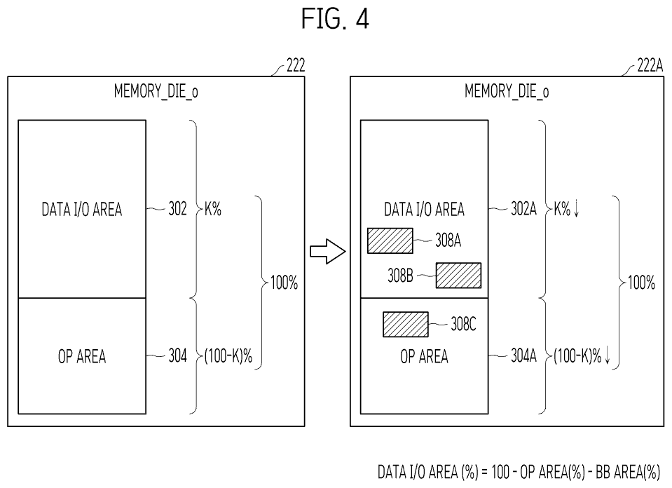

Depending on an embodiment, the memory device 220 may not be able to guarantee reliability due to wear and tear, etc. after performing a data input/output operation requested by the external device. The controller 210 can check the operating status of the memory block in the memory device 220. When it is determined that reliability cannot be guaranteed, the memory block can be determined as a bad block. Detailed operations of the bad block manager 218 will be described later with reference to FIGS. 4 to 9.

The memory device 220 can be divided into several areas. For example, the memory device 220 may include a system data area, a user data area, and a reserved area. Herein, the reserved area can include an over provisioning (OP) area. Specifically, the system data area is a place where at least one firmware, etc., used for the operations of the controller 210 may be stored. The system area can be an area (e.g., Physical Address Area) that can be accessed by a physical address only such as a physical block address of the memory device 220, not a logical address. Therefore, even if the memory system 200 including the memory device 220 is operably engaged with a computing device, which is an external device, a user might not be able to access the system data area through the computing device. According to an embodiment, access to the system data area could be permitted for limited purposes by a special command or program. The system data area can store basic information for recognizing hardware in the memory system 200 or the memory device 220, firmware for supporting the basic operation of the memory system 200, etc.

The system data area is allocated for the operations of the memory system 200, and importance of the data entries stored therein is higher than in other areas. However, data input/output might not occur as frequently as in other areas. Therefore, the controller 210 can set a standard for the memory block used as the system data area. According to an embodiment, the memory block used as the system data area might have a lower standard or reference regarding a read count and a write/delete count than a memory block used as the user data area. For example, if the write/delete count of a specific memory block is ‘200’, the memory block can be used as the user data area, but might not be used as the system data area.

The user data area can store user data entries to be transmitted to a computing device, which is an external device that the memory system 200 links to. Representative data entries included in the user data area can include an operating system (OS), file system information, application programs, etc.

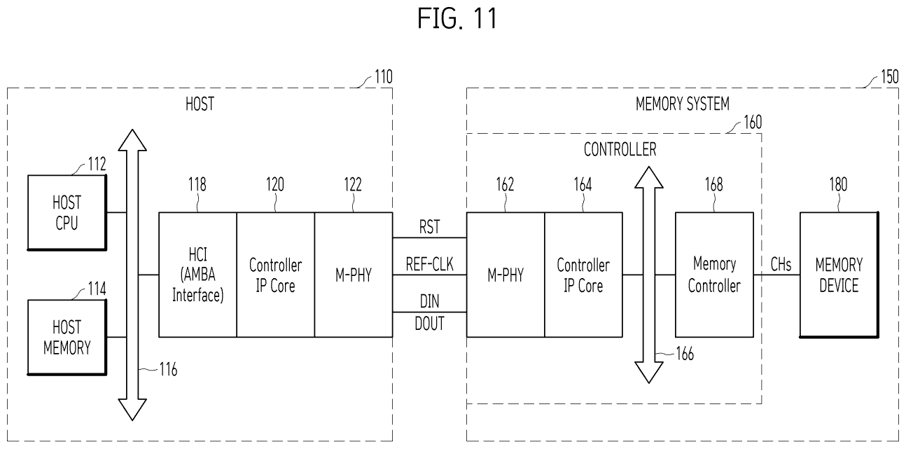

The user data area can be an area (Logical Address Area) that is accessed using a logical address or a logical block address, etc. For example, a Logical Block Address (LBA) is a format used to specify the location of a data block recorded in a storage device linked to a computing device, according to the Logical Block Addressing method. In a conventional hard disk, an addressing method that indicates the cylinder, head, and sector (Cylinder-Head-Sector, CHS), which are physical structures included in the hard disk, was used. However, the address system corresponding to the physical structure of the hard disk reached its limit as a storage capacity of the hard disk increased. In such a large-capacity storage device, addresses can be specified by arranging sectors in a logical order in a row (e.g., starting from 0) without corresponding to the physical structure of the hard disk and assigning numbers to the sectors. Instead of a computing device (e.g., a host 110, see FIG. 11) that can be coupled to the memory system 200 transmitting or pointing to data only with a logical block address LBA, the controller 210 included in the memory system 200 needs to manage the matching of a physical address, which is an address in a memory device 220 where a data entry is actually stored, and a logical block address LBA used by the host 110. Such information can be included in metadata and can be distinguished from user data entries stored or read through the host 110.

The reserved area in the memory device 220 is an area that can be used to store information for operation with a computing device or other system that the memory system 200 is coupled to, or for a configuration added to the memory system 200 according to an embodiment of the present disclosure. The reserved area, like the system data area, can be an area (Physical Address Area) that can be accessed only with a physical address such as a physical block address (PBA). Further, the memory system 220 can store data in the spare area to support various operations required or needed during a manufacturing process, a process of configuring or mounting on the host 110 or the computing device, or a process of performing operations in conjunction with the host 110 or the computing device. If the system data area is for supporting the basic operation of the memory system, the reserved area can be used for expanding operations supported by the memory system. In addition, according to an embodiment, the reserved area can include at least one memory block reserved and used to replace a bad block included in the system data area or the user data area, when the memory block in the system data area or the user data area is determined to be a bad block.

According to an embodiment, the over provisioning (OP) area or the reserved area in the memory device 220 can provide an additional storage space that cannot be accessible to the user but can be used to efficiently perform tasks such as wear leveling, garbage collection, and bad block management. The over provisioning (OP) area or the reserved area can help to improve a durability of the memory device 220 and maintain consistent performance of the memory device 220. The manufacturer of the memory device 220 can determine a ratio of the over provisioning (OP) area or the reserved area according to a configuration (e.g., storage capacity, etc.) and a main usage purpose of the memory device 220. In addition, according to an embodiment, the external device that is linked with the memory system 200 can determine the ratio of the over provisioning (OP) area or the reserved area, for example, by transferring a reconfiguration command to the memory system 200.

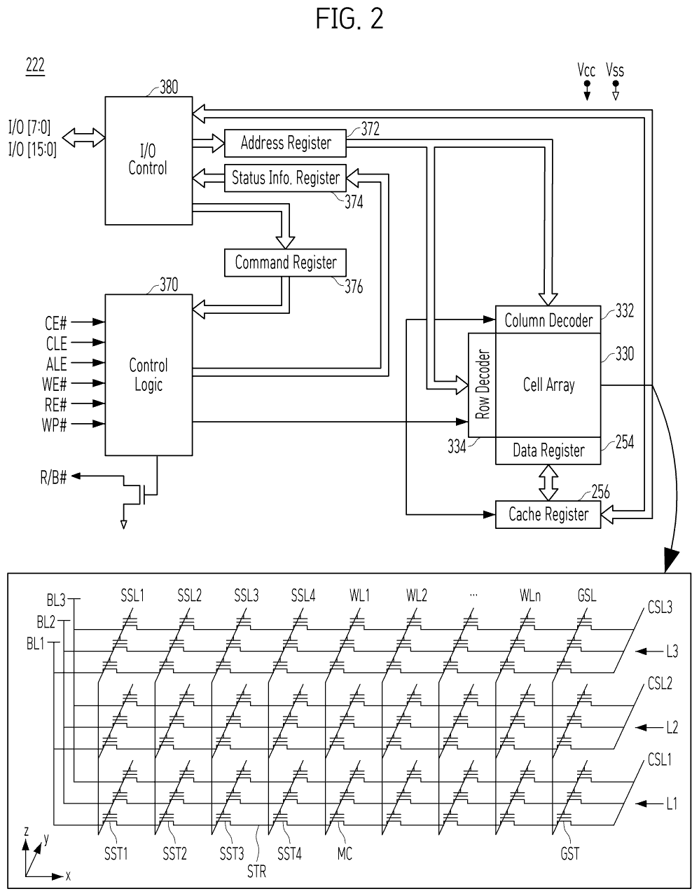

FIG. 2 illustrates a memory device according to an embodiment of the present disclosure.

Referring to FIGS. 1 and 2, the memory device 220 can include at least one memory die 222. The memory die 222 can receive or output a plurality of control signals CE #, CLE, ALE, WE #, RE #, WP #, R/B #, and receive or transmit data or operation information through channels I/O[7:0], I/O[15:0]. For example, a predetermined amount of data (e.g., 1 byte (8 bits) or 2 bytes (16 bits)) can be transmitted and received according to a channel (e.g., I/O[7:0], I/O[15:0]) coupling the memory device 222 and the controller 210.

The cell array 330 storing data entries can include a plurality of memory cells. The plurality of memory cells may be arranged in row and column directions and can have a three-dimensional structure. The cell array 330 can include volatile memory cells or non-volatile memory cells. In addition, each volatile memory cell or non-volatile memory cell can store at least 1 bit of data. The plurality of memory cells may be connected to a word line. When the word line is activated, data stored in the plurality of memory cells can be output through bit lines.

According to an embodiment, the cell array 330 can be stacked in the vertical direction (Z), and non-volatile memory cells can be placed in three-dimensional (3D) space. For example, the cell array 220 can include a plurality of memory cells MC arranged in a cell string STR in a plurality of memory layers (e.g., three memory layers L1, L2, L3). Each memory layer L1, L2, L3 is connected to a plurality of bit lines BL1, BL2, BL3 through a first end of the plurality of channel lines CL and to the common source line CSL through a second end of the plurality of channel lines CL. The memory device 150 may include a plurality of source selection lines SSL1 to SSL4 connected to source select transistors SST1 to SST3. In addition, a plurality of word lines WL1 to WLn and a ground selection line GSL may be connected to each of the memory layers L1, L2, L3. The plurality of source selection lines SSL1 to SSL4, the plurality of word lines WL1 to WLn, and the ground selection line GSL may be arranged in a direction that intersects a plurality of channel lines CL. Each of the plurality of channel lines may be described as the cell string STR. Each of the cell strings STR may include the source select transistors SST1 to SST4 respectively connected to the plurality of source selection lines SSL1 to SSL4. The ground selection line GSL may be grounded to turn off the ground selection transistor GST.

The plurality of word lines WL1 to WLn may each be connected to control gates of memory cells arranged in a column direction. Each of the plurality of bit lines BL1 to BL3 may be connected to one end of the source select transistors. A plurality of memory cells having control gate electrodes connected to each word line WL1 to WLn in the row direction can configure a page, which is a unit for storing data or a data entry. The number of pages could be changed or determined depending on a storage capacity of the memory cells.

According to an embodiment, the memory die 222 can include a plurality of pins or pads. For example, the plurality of control signals CE #, CLE, ALE, WE #, RE #, WP #, R/B #can be transmitted or received through exclusively allocated pins. The control signals can include a chip enable signal CE #, a command latch enable signal CLE, an address latch enable signal ALE, a write enable signal WE #, a read enable signal RE #, a write protect signal WP #, a status signal R/B #indicating a ready state or a busy state, and the like. The control signals CE #, CLE, ALE, WE #, RE #, WP #, R/B #can be controlled (transmitted and received) by a control logic 370 in the memory die 222.

The memory die 222 can include an input and output (I/O) control circuit 380. The input/output control circuit 380 can be connected to other devices or components (e.g., a controller) through the channels I/O[7:0], I/O[15:0]. The input/output control circuit 380 in the memory die 222 can be coupled to a plurality of registers 372, 374, 376 and a cache register 256 coupled to a cell array 330.

According to an embodiment, the input/output control circuit 380 can include a chip select decoder, while the memory die 222 may include a plurality of memory chips. Chip select function may be used to activate one of the plurality of memory chips included in or connected to a memory system or a data processing system. Depending on the embodiment, the chip select decoder may be implemented with combinational logic gates that activate one specific output line in response to an input binary code. The memory system or the data processing system can use an activated output line to activate or “select” a specific chip or device from multiple devices connected to the memory system or the data processing system. For example, if there are multiple memory chips (such as flash memory chips in solid state drives (SSDs)) on the same bus, for most operations it is impossible to communicate with all memory chips simultaneously because data entries or commands sent across the bus could be routed to all memory chips. Instead, a chip select signal can be used to select which chip to communicate with at any given time. The chip select decoder can manage and control data communication between multiple devices (e.g., the multiple memory chips) that share the same bus or connection lines in a system by activating one specific device based on an input select code/signal.

According to an embodiment, the memory die 222 may include the cache register 256, an address register 372, a status information register 374, and a command register 376. The cache register 256 can temporarily store data. When the memory die 222 performs a read operation, the cache register 256 can store a read data entry output from the cell array 330. When the memory die 222 performs a write operation or a program operation, the cache register 256 can store a write data entry. The address register 372 can store an address indicating a location of the cell array 330 where a read operation or a write operation is to be performed. The command register 376 can store a command to be executed by the memory die 222. The status information register 374 can store status information such as a result (failure/success) of an operation performed in the memory die 222 or readiness for performing an operation. For example, when a plurality of memory planes is included in a memory die in the memory die 222, the status information register 374 can store status information regarding each of the plurality of memory planes. Data, commands, and information transmitted or received through the input/output control circuit 380 in the memory die 222 can be controlled (e.g., transmitted, moved, or output) by the control logic 370.

During a read operation in the memory die 222, a row decoder 334 and a column decoder 332 can select one or more memory cells in the cell array 330 based on an address stored in the address register 372 and a control signal from the control logic 370. During a read operation, a read data entry output from the cell array 330 may be stored in a data register 254 and then transferred from the data register 254 to the cache register 256. The read data entry stored in the cache register 256 is transferred to the input/output control circuit 380 through input/output lines. The read data entry transmitted to the input/output control circuit 380 can be output to the controller through the channels I/O[7:0], I/O[15:0].

During a write operation or a program operation in the memory die 222, the row decoder 334 and the column decoder 332 can select one or more memory cells in the cell array 330 in response to an address stored in the address register 372 and a control signal from the control logic 370. During the write operation, the write data entry transferred from the controller to the input/output control circuit 380 through the channels I/O[7:0], I/O[15:0] can be stored in the cache register 256. Thereafter, the write data entry can be transferred from the cache register 256 to the data register 254. The write data entry stored in the data register 254 can be programmed in selected memory cells in the cell array 330 by the control logic 370.

The data register 254 and the cache register 256 described in FIG. 2 can be included in a read/write circuit including a sense amplifier, a page buffer, or the like. According to an embodiment, page buffers or data latches included in the memory die 222 can correspond to the data register 254 and/or the cache register 256. Further, the cache register 256 is configured to temporarily store data transmitted between the data register 254 and the input/output control circuit 380. The cache register 256 may have a pipe latch structure depending on the embodiment.

A pipeline (or pipelining) system including at least one pipe latch can include an apparatus that can parallelize a plurality of data entries input and output serially. According to an embodiment, the pipeline system is applicable to the input/output control circuit 380 or the cache register 256. Further, according to an embodiment, the pipeline system may be used to compensate for delays and noise occurring in a data transmission process as a data path through which data is transmitted within the memory die 222 of the memory system becomes longer.

FIG. 3 illustrates a configuration of a memory device according to an embodiment of the present disclosure. Specifically, referring to FIGS. 1 to 3, internal configuration of the memory device 220 and a method for accessing the internal configuration of the memory device 220 are described.

Referring to FIG. 3, in a physical domain, the memory device 220 can include a plurality of memory dies 222 (e.g., MEMORY_DIE_0, . . . , MEMORY_DIE_o). Each memory die (e.g., MEMORY_DIE_0) can include a plurality of memory planes 236 (e.g., MEMORY_PLANE_0, . . . , MEMORY_PLANE_n). Each memory plane (e.g., MEMORY_PLANE_0) can include a plurality of memory blocks 234 (e.g., MEMORY_BLOCK_0, MEMORY_BLOCK_1, . . . , MEMORY_BLOCK_m). Each memory block (e.g., MEMORY_BLOCK_0) can include a plurality of pages 232 (e.g., WL_0_LSB, WL_0_MSB, . . . , WL_p_MSB). The number of pages 232 (e.g., WL_0_LSB, WL_0_MSB, . . . , WL_p_MSB) can be determined based on the number of word lines and the number of bits of data stored in each memory cell.

According to an embodiment, the memory block (e.g., MEMORY_BLOCK_0) can correspond to a memory block in which plural memory cells included in the three-dimensional cell array 330 described in FIG. 2 are divided into multiple row units. The memory plane (e.g., MEMORY_PLANE_0) can correspond to a memory plane in which multiple column units are divided. The multiple row units can be a preset number of row groups that may vary depending on the arrangement and structure of local word lines, global word lines, etc. Likewise, the multiple column units can be a preset number of column groups (e.g., string groups) that may vary depending on arrangement and structure of local source lines, global source lines, etc. For example, the cell array 330 can include memory blocks, each divided into 32-, 64-, or 128-word line units. The cell array 330 can include memory planes, each divided into 8- or 16-string units.

Referring to FIG. 3, in a logical domain, the memory device 220 can include a plurality of super blocks 302. Each super block 302 can include a plurality of logical blocks 304. Each logical block 304 can include a plurality of logical pages 306.

According to an embodiment, sizes of each logical block 304 and each memory block 234 can be the same, and sizes of each logical page 306 and each page 232 can be the same. In another embodiment, the sizes of each logical block 304 and each memory block 234 can have a multiple relationship (e.g., 0.2 times, 0.5 times, 2 times, 4 times, or etc.). The sizes of each logical page 306 and each page 232 can have the same or different multiple relationship. These relationships can be determined based on the internal configuration of the memory device 220 and the usage environment of the memory system 200 (e.g., a protocol agreed upon for performing data communication with the host 102, which is an external device).

The configuration of the memory device 220 in the logical domain can vary depending on an embodiment. In the physical domain, as the number of memory cells included in the memory device 220 per unit area or unit volume increases, storage capability of data that can be stored in the memory device 220 also increases. As the storage capability of data that can be stored increases, a scheme can be designed and used to increase efficiency in inputting and outputting data (e.g., throughput). For example, the internal configuration of the memory device 220 in the logical domain can be designed to improve the efficiency of data input/output.

The flash translation layer (FTL) 218 described in FIG. 1 can perform a mapping operation that associates an element in the logical domain for the memory device 220 with an element in the physical domain. In addition, the bad block manager 218 can determine a defect in the corresponding element based on status information regarding the element in the physical domain corresponding to the element in the logical domain and perform a bad block management operation to replace the defect with an operable element.

FIG. 4 illustrates a configuration change based on a bad block in a memory die according to an embodiment of the present disclosure.

Referring to FIGS. 1 to 4, the memory die 222 can include a cell array 330 which has a two-dimensional or three-dimensional structure including a plurality of memory cells. According to an embodiment, the cell array 330 in the memory die 222 can include a data input/output area 302 and an over provisioning (OP) area 304. If the data input/output area 302 is K % of a total storage capacity (100%) in which data can be stored in the memory die 222, the over provisioning area 304 can be (100-K) % of the total storage capacity. According to an embodiment, the memory die 222 can include a system data area.

According to an embodiment, plural areas can be additionally set in the memory die 222A. Due to a bad block occurring in various areas within the memory die 222A, sizes of the plural areas to which a bad block belongs can be reduced. In order to avoid reducing a size of the data input/output area 302 (e.g., DATA I/O AREA (%)), the over-provisioning (OP) area 304 can be used instead of the bad block.

For example, at least one bad block 308A, 308B, 308C can be identified during a test process after manufacturing the memory die 222A or during use of the memory die 222A. At least one bad block 308A, 308B, 308C can occur, or be found, in the data input/output area 302 or the over-provisioning (OP) area 304. Due to at least one bad block 308A, 308B, 308C occurring in the data input/output area 302 or the over-provisioning (OP) area 304, a ratio occupied by the data input/output area 302 in the memory die 222A can decrease (K % 4), and a ratio occupied by the over-provisioning (OP) area (304) can also decrease ((100-K) % \). For example, the size of the data input/output area 302 (DATA I/O AREA (%)) can be set by a value obtained by excluding the size of the over-provisioning (OP) area 304 (OP AREA (%)) and the size of the bad block (BB AREA (%)) from the total storage capacity (100%) capable of storing data.

According to an embodiment, when a bad block occurs in the data input/output area 302, memory cells in other strings connected to the same word line as the corresponding bad block or memory cells connected to a word line adjacent to the corresponding bad block might not be used as, or allocated to, the data input/output area 302. The operable memory cells in the corresponding position may be set as the over provisioning (OP) area 304.

The memory system 200 can include the plurality of memory dies 222, 224, 226, 228. When a bad block occurs in the plurality of memory dies 222, 224, 226, 228 the sizes of the bad blocks in the plurality of memory dies 222, 224, 226, 228 might be different. When all memory cells associated with or located around a bad block occurring or found in each of the plurality of memory dies 222, 224, 226, 228 are set to the over-provisioning (OP) area 304, the sizes of the over-provisioning OP areas 304 in each of the plurality of memory dies 222, 224, 226, 228 can be different. This difference in sizes can cause a difference or deviation in performance for operations performed within each of the plurality of memory dies 222, 224, 226, 228. For example, in the memory system 200 that improves the performance of a write operation by using the over-provisioning (OP) area 304 as a write buffer during a random data write, the difference in sizes of the over-provisioning (OP) areas 304 in the plurality of memory dies 222, 224, 226, 228 can have a significant impact on the performance of the random data write operations performed within the plurality of memory dies 222, 224, 226, 228.

If the operations performed in each of the plurality of memory dies 222, 224, 226, 228 coupled to the controller 210 are not uniform, overheads may increase when the controller 210 performs the plurality of operations in parallel for distributing data entries over the plurality of memory dies 222, 224, 226, 228. For example, if times at which read or write operations are performed are different in each of the plurality of memory dies 222, 224, 226, 228, the controller 210 can need to adjust timings of operations performed in other memory dies based on a timing of operations of a specific memory die in order to schedule the plurality of read or write operations performed in parallel within the plurality of memory dies 222, 224, 226, 228. Or the controller 210 can delay an operation performed within another memory die based on a completion of an operation performed within a specific memory die. When the performance of data input/output operations or background operations performed within the plurality of memory dies 222, 224, 226, 228 is uniform, the controller 210 can reduce the overheads to control a scheduling or mechanism for distributed processing or parallel processing. Thus, the controller 210 can use resources more efficiently.

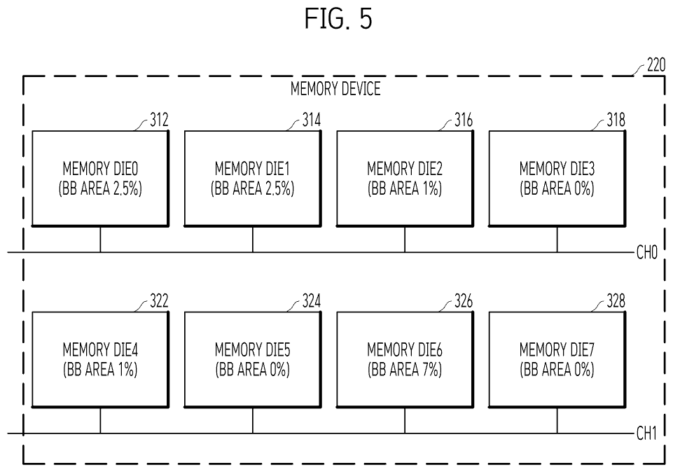

FIG. 5 illustrates a memory device including a plurality of memory dies.

Referring to FIG. 5, the memory device 220 can include a plurality of memory dies 312, 314, 316, 318, 322, 324, 326, 328. The plurality of memory dies 312, 314, 316, 318, 322, 324, 326, 328 can include a plurality of first memory dies 312, 314, 316, 318 coupled to a first channel CH0 and a plurality of second memory dies 322, 324, 326, 328 coupled to a second channel CH1. The memory device 220 can be coupled to the controller 210 via the plurality of channels CH0, CH1.

FIG. 5 illustrates the size of a bad block in each of the plurality of memory dies 312, 314, 316, 318, 322, 324, 326, 328. For example, bad blocks in the first memory die 312 and the second memory die 314 can have a size of 2.5% of the total capacity. But the fourth memory die 318, the sixth memory die 324, and the eighth memory die 328 can have no bad blocks (0%). Moreover, the bad blocks in the seventh memory block 326 can have a size of 7% of the total capacity. As described in FIG. 5, the bad blocks occurring in each of the plurality of memory dies 312, 314, 316, 318, 322, 324, 326, 328 in the memory device 220 might not have the same or uniform size.

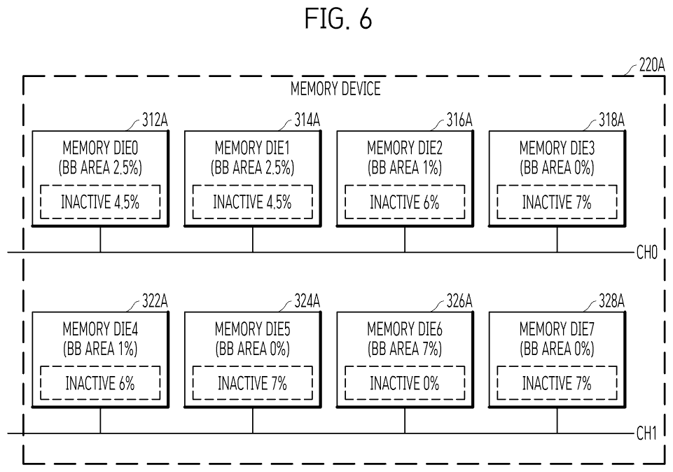

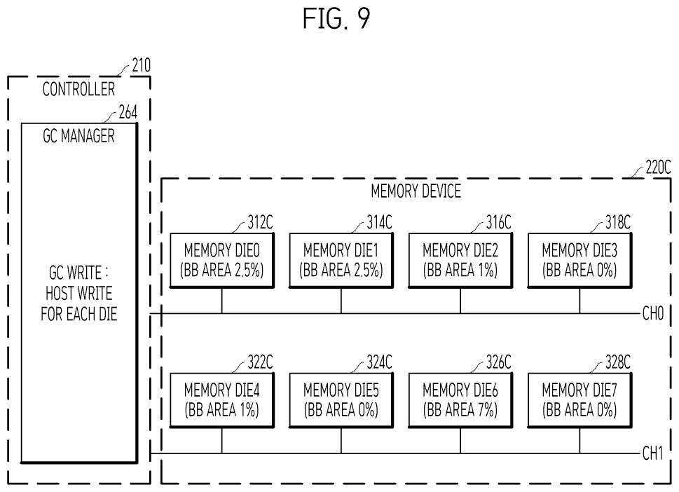

Hereinafter, with reference to FIGS. 6 and 9, when each of the plurality of memory dies 312, 314, 316, 318, 322, 324, 326, 328 in the memory device 220 shown in FIG. 5 can include bad blocks of different sizes, a control operation for uniformizing performance of operations performed within the plurality of memory dies 312, 314, 316, 318, 322, 324, 326, 328 performed by the memory system 200 or the controller 210 will be specifically described.

FIG. 6 illustrates a first control operation performed in a memory system according to an embodiment of the present disclosure.

Referring to FIG. 6, a memory device 220A can include a plurality of memory dies 312A, 314A, 316A, 318A, 322A, 324A, 326A, 328A. The plurality of memory dies 312A, 314A, 316A, 318A, 322A, 324A, 326A, 328A are described as an example in which the plurality of memory dies 312, 314, 316, 318, 322, 324, 326, 328 described in FIG. 5 have substantially the same bad block sizes.

The first control operation performed by the memory system 200 or the controller 210 can set an inactive area within the plurality of memory dies 312A, 314A, 316A, 318A, 322A, 324A, 326A, 328A. Here, the inactive area refers to an unused or not working area within the plurality of memory dies 312A, 314A, 316A, 318A, 322A, 324A, 326A, 328A, and an active area, which is an area other than an inactive area, refers to a used or working area for data input or output. According to an embodiment, the inactive area within the memory system 200 might be permanently unused or might be used according to a change in an operating environment or an operating condition. For example, the setting and changing of the inactive area from the active area or vice versa can be performed as a background operation by the controller 210 within the memory system 200.

The inactive area set in each of the plurality of memory dies 312A, 314A, 316A, 318A, 322A, 324A, 326A, 328A can be based on a difference in sizes of bad blocks of the plurality of memory dies 312A, 314A, 316A, 318A, 322A, 324A, 326A, 328A. For example, the seventh memory block 326A having the largest-sized bad block among the plurality of memory dies 312A, 314A, 316A, 318A, 322A, 324A, 326A, 328A can be compared with the first memory block 312A. A difference in the bad block sizes of the seventh memory block 326A and the first memory block 312A is 4.5% (=7%−2.5%). Therefore, the memory system 200 or the controller 210 can set an area corresponding to 4.5% of the total storage capacity in the first memory block 312A as an inactive area (INACTIVE). Herein, the inactive area can include at least one cell string or at least one memory plane included in the first memory block 312A.

During the first control operation, the memory system 200 or the controller 210 might not set any inactive area in the seventh memory block 326A having the largest size bad block. The memory system 200 or the controller 210 can set an inactive area based on a difference in the sizes of bad blocks in the remaining memory dies 312A, 314A, 316A, 318A, 322A, 324A, 328A except for the seventh memory block 326A among the plurality of memory dies 312A, 314A, 316A, 318A, 322A, 324A, 326A, 328A. For example, the memory system 200 or the controller 210 can set the inactive area to 7% of the total capacity for each of the fourth memory die 318A, the sixth memory die 324A, and the eighth memory die 328A that do not have any bad block. Through the first control operation, the sum of the bad block size and a size of the inactive area in each of the plurality of memory dies 312A, 314A, 316A, 318A, 322A, 324A, 326A, 328A in the memory device 220A can be substantially the same (e.g., 7% of the total capacity in each memory die in FIGS. 5 and 6).

Through the first control operation, the size of the over provisioning (OP) area included in each of the plurality of memory dies 312A, 314A, 316A, 318A, 322A, 324A, 326A, 328A can be maintained the same. The inactive area set in each of the plurality of memory dies 312A, 314A, 316A, 318A, 322A, 324A, 326A, 328A might not be included in the over provisioning (OP) area. Through the first control operation, the memory system 200 or the controller 210 can make the sizes of the data input/output area and the over provisioning (OP) area in the plurality of memory dies 312A, 314A, 316A, 318A, 322A, 324A, 326A, 328A substantially the same, thereby evenly adjusting the performance of the operations performed in the plurality of memory dies 312A, 314A, 316A, 318A, 322A, 324A, 326A, 328A.

The inactive areas set in the plurality of memory dies 312A, 314A, 316A, 318A, 322A, 324A, 326A, 328A might not be used in data input/output operations or background operations performed within the memory device 220. According to an embodiment, the inactive areas in each of the plurality of memory dies 312A, 314A, 316A, 318A, 322A, 324A, 326A, 328A can be set and used for the purpose of maintaining equational sizes of the data input/output areas and the over-provisioning (OP) areas included in each of the plurality of memory dies 312A, 314A, 316A, 318A, 322A, 324A, 326A, 328A. For example, when some of the data input/output area or the over-provisioning (OP) area included in each of the plurality of memory dies 312A, 314A, 316A, 318A, 322A, 324A, 326A, 328A has passed their lifespan and can no longer be used, there can be a difference in the sizes of the data input/output areas or over-provisioning (OP) areas of the plurality of memory dies 312A, 314A, 316A, 318A, 322A, 324A, 326A, 328A. In this case, the inactive area in each of the plurality of memory dies 312A, 314A, 316A, 318A, 322A, 324A, 326A, 328A can be reset and used to reduce a difference in sums of the data input/output areas or over-provisioning (OP) areas of the plurality of memory dies 312A, 314A, 316A, 318A, 322A, 324A, 326A, 328A.

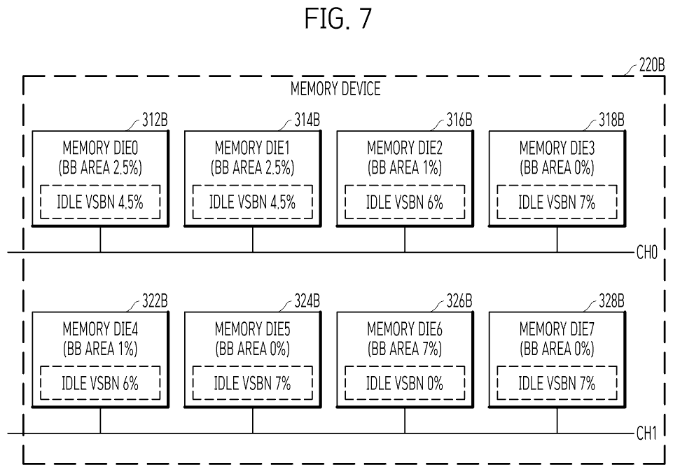

FIG. 7 illustrates a second control operation performed in a memory system according to an embodiment of the present disclosure.

Referring to FIG. 7, a memory device 220B can include a plurality of memory dies 312B, 314B, 316B, 318B, 322B, 324B, 326B, 328B. The plurality of memory dies 312B, 314B, 316B, 318B, 322B, 324B, 326B, 328B are described as an example in which the plurality of memory dies 312, 314, 316, 318, 322, 324, 326, 328 described in FIG. 5 have substantially the same bad block sizes.

The second control operation performed by the memory system 200 or the controller 210 can set an unused super block (IDLE VSBN) within the plurality of memory dies 312B, 314B, 316B, 318B, 322B, 324B, 326B, 328B. Here, the unused super block (IDLE VSBN) is similar to the inactive area (INACTIVE) described in FIG. 6. There is a difference in the unused super block (IDLE VSBN) which can be set in a unit of word lines (e.g., in a unit of rows), whereas the inactive area (INACTIVE) can be set in a unit of cell strings (e.g., in a unit of columns).

The second control operation can set the unused super block (IDLE VSBN) for each of the plurality of memory dies 312B, 314B, 316B, 318B, 322B, 324B, 326B, 328B, based on the difference in the sizes of bad blocks of the plurality of memory dies 312B, 314B, 316B, 318B, 322B, 324B, 326B, 328B. For example, the seventh memory block 326B having the largest size bad block among the plurality of memory dies 312B, 314B, 316B, 318B, 322B, 324B, 326B, 328B can be compared with the first memory block 312B. A difference in the bad block sizes between the seventh memory block 326B and the first memory block 312B is 4.5% (=7%−2.5%). Therefore, the memory system 200 or the controller 210 can set, as the unused super block (IDLE VSBN), at least one super block corresponding to the difference (i.e., 4.5%) of the total storage capacity in the first memory block (312B).

During the second control operation, the memory system 200 or the controller 210 might not set any unused super block (e.g., 0%) in the seventh memory block (326B) having the largest bad block size. The memory system 200 or the controller 210 may set an unused super block based on the difference in the bad block sizes in the remaining memory dies 312B, 314B, 316B, 318B, 322B, 324B, 326B, 328B except for the seventh memory block 326B among the plurality of memory dies 312B, 314B, 316B, 318B, 322B, 324B, 326B, 328B. For example, the memory system 200 or the controller 210 can set an unused super block to 7% of the total capacity for each of the fourth memory die 318B, the sixth memory die 324B, and the eighth memory die 328B that do not have any bad block. Through the second control operation, the sum of the bad block size and a size of the unused super block in each of the plurality of memory dies 312B, 314B, 316B, 318B, 322B, 324B, 326B, 328B in the memory device 220B can be substantially the same (e.g., 7% of the total capacity in each memory die in FIGS. 5 and 7).

Similar to the inactive area described in FIG. 6, the unused super block described in FIG. 7 may not be used in data input/output operations or background operations performed in the memory device 220. However, depending on the embodiment, the inactive area set in each of the plurality of memory dies 312B, 314B, 316B, 318B, 322B, 324B, 326B, 328B can be used to reduce a difference in sizes of the data input/output area or the over-provisioning (OP) area in each of the plurality of memory dies 312B, 314B, 316B, 318B, 322B, 324B, 326B, 328B.

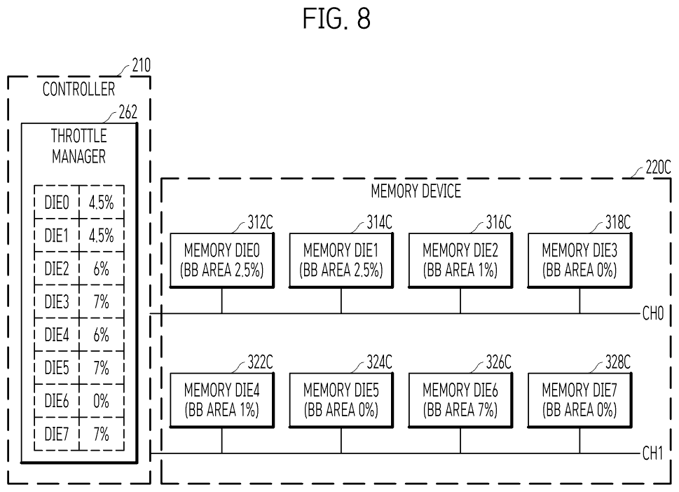

FIG. 8 illustrates a third control operation performed in a memory system according to an embodiment of the present disclosure. FIG. 9 illustrates a fourth control operation performed in a memory system according to an embodiment of the present disclosure.

Referring to FIGS. 8 and 9, a memory device 220C can include a plurality of memory dies 312C, 314C, 316C, 318C, 322C, 324C, 326C, 328C. The plurality of memory dies 312C, 314C, 316C, 318C, 322C, 324C, 326C, 328C are described as an example in which the plurality of memory dies 312, 314, 316, 318, 322, 324, 326, 328 described in FIG. 5 have substantially the same bad block sizes. In the third control operation and the fourth control operation, an inactive area or an unused super block might not be set for each of the plurality of memory dies 312C, 314C, 316C, 318C, 322C, 324C, 326C, 328C within the memory device 220C. In addition, because the sizes of bad blocks occurring or found in each of the plurality of memory dies 312C, 314C, 316C, 318C, 322C, 324C, 326C, 328C within the memory device 220C are different, the sizes of over provisioning (OP) areas set for the plurality of memory dies 312C, 314C, 316C, 318C, 322C, 324C, 326C, 328C within the memory device 220C can be differently established. However, the controller 210 coupled to each of the plurality of memory dies 312C, 314C, 316C, 318C, 322C, 324C, 326C, 328C within the memory device 220C can control a throttle or control a ratio of host write operations and garbage collection write operations.

Referring to FIG. 8, a throttle manager 262 within the controller 210 can determine different throttling levels for operations performed in the plurality of memory dies 312C, 314C, 316C, 318C, 322C, 324C, 326C, 328C within the memory device 220C. Typically, the throttling is an operation to forcibly lower a clock and a voltage or forcibly turn off power to reduce heat generation when circuits, CPU, GPU, etc. of a PC, a laptop, or a mobile device overheat excessively, in order to avoid damage to the device. The throttle manager 262 can set a throttle level corresponding to a difference in the bad block sizes in order to uniformly control performance of operations performed in the plurality of memory dies 312C, 314C, 316C, 318C, 322C, 324C, 326C, 328C within the memory device 220C. Through the third control operation, the throttle manager 262 can compare the seventh memory block 326C having the largest size bad block among the plurality of memory dies 312C, 314C, 316C, 318C, 322C, 324C, 326C, 328C with the first memory block 312C. Because the difference in the bad block size between the seventh memory block 326C and the first memory block 312C is 4.5% (=7%-2.5%), the throttle manager 262 can set the throttle level for the first memory block 312C to be 4.5% higher than the throttle level of the seventh memory block 326C (e.g., decrease lower 4.5% of operation performance than the seventh memory block 326C).

In FIG. 8, an example is described in which the throttle manager 262 adjusts the throttle level of each of the plurality of memory dies 312C, 314C, 316C, 318C, 322C, 324C, 326C, 328C differently based on the difference in the bad block sizes of the plurality of memory dies 312C, 314C, 316C, 318C, 322C, 324C, 326C, 328C. According to an embodiment, the third control operation can be performed based on a multiple relationship (e.g., 0.1 times, 0.2 times, 0.5 times, 2 times, or 3 times, etc.) of the bad block size difference and the throttle level difference, which can be determined based on configurations and operating characteristics of the memory device 220C. Through the third control operation, the controller 210 can adjust values or levels for equational performance of operations performed in the plurality of memory dies 312C, 314C, 316C, 318C, 322C, 324C, 326C, 328C within the memory device 220C. In addition, according to an embodiment, when the influence of the bad block size on the data input/output operations or the background operations performed in the plurality of memory dies 312C, 314C, 316C, 318C, 322C, 324C, 326C, 328C is calculated or estimated, the throttle manager 262 can set a throttle level based on a value that can compensate for a result calculated or estimated through the third control operation.

Referring to FIG. 9, since the sizes of bad blocks occurring or found in each of the plurality of memory dies 312C, 314C, 316C, 318C, 322C, 324C, 326C, 328C within the memory device 220C are different, the sizes of over-provisioning (OP) areas set for the plurality of memory dies 312C, 314C, 316C, 318C, 322C, 324C, 326C, 328C within the memory device 220C can vary. Since the sizes of the over-provisioning (OP) areas set for the plurality of memory dies 312C, 314C, 316C, 318C, 322C, 324C, 326C, 328C vary, data input/output performance can be adjusted according to the sizes of the over-provisioning (OP) areas. The controller 210 can set a ratio of host write operations and garbage collection write operations (Ratio of Host Write and GC Write) for each of the plurality of memory dies 312C, 314C, 316C, 318C, 322C, 324C, 326C, 328C through the fourth control operation.

According to an embodiment, the sizes of an over-provisioning (OP) areas can vary according to the sizes of bad blocks occurring or found in the plurality of memory dies 312C, 314C, 316C, 318C, 322C, 324C, 326C, 328C in the memory device 220C. According to the difference in the sizes of the over-provisioning (OP) areas, the ratio of host write operations and garbage collection write operations (Ratio of Host Write and GC Write) can be set for each memory die. For instance, the ratio of host write operations and garbage collection write operations (Ratio of Host Write and GC Write) in the memory system 200 can be set to a preset ratio (e.g., 8:2) in multiple memory dies 312C, 314C, 316C, 318C, 322C, 324C, 326C, 328C. The controller 210 can maintain the ratio of host writes to garbage collection writes (Host Write and GC Write) as the preset ratio of 8:2 in the fourth memory die 318C, the sixth memory die 324C, and the eighth memory die 328C that do not have any bad block. However, due to a 2.5% bad block size difference or the over-provisioning (OP) area in the first memory die 312C, an actual ratio of host writes operation and garbage collection writes operation (Ratio of Host Write and GC Write) in the first memory die 312C becomes 8.2:1.8 from the preset ratio of 8:2. Therefore, a garbage collection (GC) manager 264 in the controller 210 can adjust the ratio of host write operations and garbage collection write operations (Ratio of Host Write and GC Write) in the first memory die 312C, in order to revert the actual ratio (e.g., 8.2:1.8) to the present ratio (e.g., 8:2) which is the same as the ratio of host write operations and garbage collection write operations (Ratio of Host Write and GC Write) in the fourth memory die 318C, the sixth memory die 324C, and the eighth memory die 328C that do not have any bad block. To adjust this, the garbage collection manager 264 can determine a changed value using the following equation 1.

Changed Value=(Current GC ratio×Current OP Size (%)/100)/(Current OP Size (%)+Bad Block Size (%))×100 [Equation 1]

According to an embodiment, the formula 1 can be determined based on the operating characteristics of the plurality of memory dies 312C, 314C, 316C, 318C, 322C, 324C, 326C, 328C in the memory device 220C.

Referring to FIGS. 6 to 9, through the first to fourth control operations, the memory system 200 or the controller 210 can enable the plurality of memory dies in the memory device to have substantially the same operating performance. According to an embodiment, the memory system 200 or the controller 210 can combine or mix the first to fourth control operations. For example, an inactive area or an unused super block can be set corresponding to a difference in the size of bad blocks in a plurality of memory dies connected through the first channel CH0. An inactive area or an unused super block can be set corresponding to a difference in the sizes of the bad blocks in the plurality of memory dies connected through the second channel CH1. Thereafter, the memory system 200 or the controller 210 can set a throttle level corresponding to the channel or set a ratio of host write operations and garbage collection write operations (Ratio of Host Write and GC Write) corresponding to the channel, so that the plurality of memory dies connected to the first channel CH0 and the plurality of memory dies connected to the second channel CH1 can have the same performance.

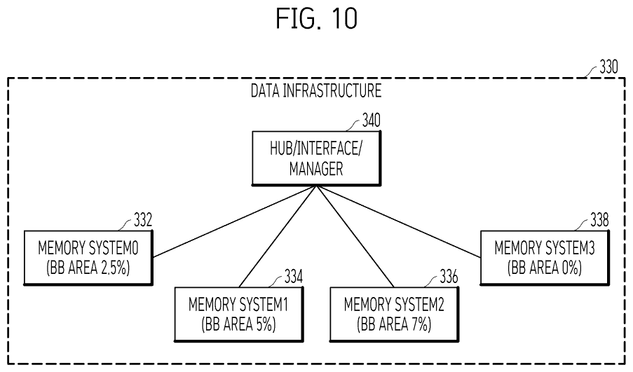

FIG. 10 illustrates a data infrastructure according to an embodiment of the present disclosure.

Referring to FIG. 10, the data infrastructure 330 can include plural memory systems 332, 334, 336, 338 and a hub, interface, or manager 340. Here, an example of the data infrastructure 330 is a data center or a mass storage device.

As described in FIGS. 5 to 9, as plural memory dies included in the memory system may have different bad block sizes, the plural memory systems 332, 334, 336, 338 included in the data infrastructure 330 can also have different bad block sizes. Due to a difference in bad block sizes, performances of data input/output operations or background operations performed in the plural memory systems 332, 334, 336, 338 can be different from each other. The hub, interface, or manager 340 can control the plural memory systems 332, 334, 336, 338 based on the first to fourth control operations described in FIGS. 6 to 9, so that the plural memory systems 332, 334, 336, 338 can have the substantially same, equational, or uniform performance of the data input/output operations or the background operations. When the plural memory systems 332, 334, 336, 338 included in the data infrastructure 330 have substantially similar and uniform performance, the efficiency of maintenance, repair, and management of the data infrastructure 330 can be improved.

FIG. 11 illustrates a memory system according to an embodiment of the present disclosure.

Referring to FIG. 11, the first data processing apparatus can include a host 110 and a memory system 150. The host 110 and the memory system 150 can include a Universal Flash Storage (UFS) electrical interface. The memory system 150 can have characteristics of UFS memory device. The characteristics can include low power consumption, high data throughput, low electromagnetic interference, and large memory subsystem efficiency optimization. The UFS electrical interface may be based on a differential interface suggested by a Mobile Industry Processor Interface (MIPI) M-PHY specification, which establishes and supports interconnection of the UFS interface with a MIPI Unified Protocol (UniPro) specification.

According to an embodiment, the host 110 can be an entity or a device that has the characteristics of a computing device that includes one or more Small Computer System Interface (SCSI) initiator devices. The host 110 and the memory system 150 may use a predetermined set of rules or procedures for data communication or a preset interface to transmit and receive data therebetween. Examples of sets of rules or procedures for data communication standards or interfaces supported by the host 110 and the memory system 150 for sending and receiving data include Universal Serial Bus (USB), Multi-Media Card (MMC), Parallel Advanced Technology Attachment (PATA), Small Computer System Interface (SCSI), Enhanced Small Disk Interface (ESDI), United Drive Electronics (IDE), Peripheral Component Interconnect Express (PCIe or PCI-e), Serial-attached SCSI (SAS), Serial Advanced Technology Attachment (SATA), Mobile Industry Processor Interface (MIPI), and the like. According to an embodiment, the host 110 and the memory system 150 may be coupled to each other through a Universal Serial Bus (USB). The Universal Serial Bus (USB) is a highly scalable, hot-pluggable, plug-and-play serial interface that ensures cost-effective, standard connectivity to peripheral devices such as keyboards, mice, joysticks, printers, scanners, storage devices, modems, video conferencing cameras, and the like.

According to an embodiment, the memory system 150 can be implemented as any of various types of storage devices such as a solid state drive (SSD), a multi-media card (MMC), an embedded MMC (eMMC), a reduced size MMC (RS-MMC), or a micro-MMC, a Secure Digital (SD) card in a form of the micro-SD, a Universal Storage Bus (USB) storage device, a Universal Flash Storage (UFS) device, a compact flash (CF) card, a Smart Media card, a Memory Stick, and etc.

The host 110 can include a host central processing unit (CPU) 112, a host memory 114, a bus interface 116, a host controller interface (HCI) 118, at least one controller IP core 120, and a physical layer (M-PHY) 122. The host central processing unit 112 may be capable of executing at least one application. The host memory 114 may store data to be transmitted to the host central processing unit 112 or data generated by the host central processing unit 112. The bus interface 116 may be an interface for communication between components included in the host 110. The host controller interface 118 may output or receive data to or from an external device (e.g., memory system 150) coupled to the host 110. The at least one controller IP core 120 may perform various functions such as data, command or control signal transmission, error handling, power management, and the like. The physical layer 122 may perform communication based on the MIPI M-PHY specification.

The at least one controller IP core 120 can manage and control communication between the host 110 and the memory system 150. For example, the controller IP core 120 can be used to transmit data from the host 110 to the memory system 150, and to perform operations for detecting and recovering an error that occurred in data, which is transmitted from the memory system 150 to the host 110.

The physical layer 122 can perform communication according to a serial communication protocol developed by the Mobile Industry Processor Interface (MIPI) organization. The physical layer 122 can be designed for high-speed data transmission used in mobile devices and other low-power devices. The physical layer 122 can be used for communication between various devices such as mobile displays, cameras, sensors, memory, etc., depending on the embodiment. In particular, the physical layer 122 can support low-power operation so that the physical layer 122 can minimize power consumption to extend a life of a battery embedded in mobile devices. In addition, the physical layer 122 can provide a high bandwidth and a fast data transmission speed via a parallel processing scheme using a multi-lane architecture, meeting the needs of high-definition video and large file transmission.

The host controller interface 118 can provide communication with the at least one controller IP core 120 and other components coupled via the bus interface 116. For example, the AMBA (Advanced Microcontroller Bus Architecture) is a bus-based communication protocol and interface developed by ARM Ltd. AMBA interface, which includes AXI (Advanced extensible Interface), AHB (Advanced High-performance Bus), or APB (Advanced Peripheral Bus), which can be used for communication between intellectual property (IP) cores in System-on-Chip (SoC) designs. Further, the bus interface 116 can also support exchange of data or control signals between various components and the at least one controller IP core 120, which are included in the host 110.

Referring to FIG. 11, the physical layer 122 in the host 110 can transmit or receive, to or from the memory system 150, a reset signal (RST), a reference clock (REF-CLK), input data or write data (DIN), and output data or read data (DOUT).

The memory system 150 can include a controller 160 and a memory device 180. Herein, the memory device 180 may include at least one data storage space including volatile memory cells or non-volatile memory cells. A detailed description of the memory device 180 will be described later with reference to FIG. 3.

The controller 160, which is coupled to the memory device 180 through at least one channel (CHs), can receive signals, commands, or data input from the host 110 and perform operations responsive to the signals, the commands, the data. For example, the controller 160 can store data in the memory device 180 when the data is input from the host 110. The controller 160 can transmit, to the host 110, data, which is requested by the host 110 and received from the memory device 150. The controller 160 may include a physical layer (M-PHY) 162, at least one controller IP core 164, a bus interface 166, and a memory controller 168.

The controller 160 included in the memory system 150 can include the physical layer 162 that is substantially similar to the physical layer 122 included in the host 110. The physical layer 162 may receive or transmit signals or data transmitted from or to the host 110. For example, the physical layer 162 and the physical layer 122 can operate as counter parts for each other.

According to an embodiment, the at least one controller IP core 164 in the memory system 150 can be substantially the same as the at least one controller IP core 120 in the host 110. In another embodiment, the at least one controller IP core 164 can be different from the at least one controller IP core 120. The configuration of the at least one controller IP core 164 can be determined or established in response to the bus interface 166 that supports communication between various components included in the memory system 150.

The memory controller 168 may be designed or configured based on the configuration of the memory device 180. For example, when the memory device 180 is a flash memory, the memory controller 168 may support communication with a flash memory such as a NAND or NOR device. For example, the memory controller 168 can support communication schemes and protocols set in the ONFI (Open NAND Flash Interface). The ONFI can use a data path (e.g., a channel, a way, etc.) that includes signal lines that are capable of supporting bidirectional transmission and reception of a 8-bit or 16-bit data unit between different components. Data communication between the controller 160 and the memory device 180 can be performed through a device that supports an interface designed for at least one scheme among asynchronous SDR (Asynchronous Single Data Rate), synchronous DDR (Synchronous Double Data Rate), and Toggle DDR (Toggle Double Data Rate).

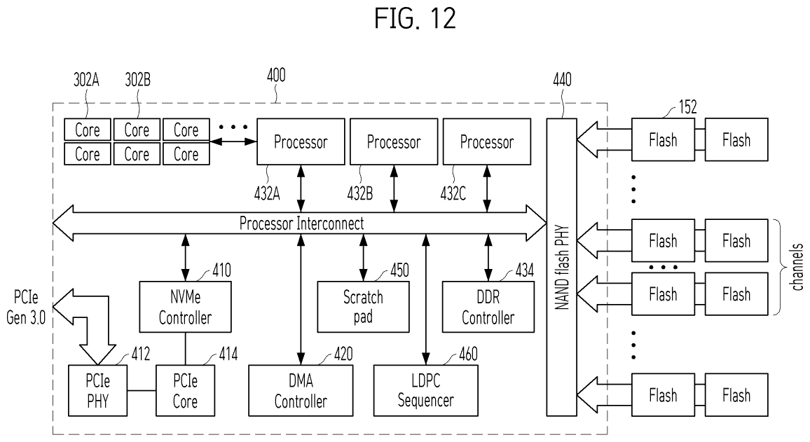

FIG. 12 illustrates a memory system according to an embodiment of the present disclosure. FIG. 12 shows a memory system including multiple cores or multiple processors, which is an example of a data storage system. The memory system may support the Non-Volatile Memory Express (NVMe) protocol.

The NVMe is a type of transfer protocol designed for a solid-state memory that could operate much faster than a conventional hard drive. The NVMe can support higher input/output operations per second (IOPS) and lower latency, resulting in faster data transfer speeds and improved overall performance of the data storage system. Unlike SATA which has been designed for a hard drive, the NVMe can leverage the parallelism of solid-state storage to enable more efficient use of multiple queues and processors (e.g., CPUs). The NVMe is designed to allow hosts to use many threads to achieve higher bandwidth. The NVMe can allow the full level of parallelism offered by SSDs to be fully exploited. However, because of limited firmware scalability, limited computational power, and high hardware contention within SSDs, the memory system might not process a large number of I/O requests in parallel.

Referring to FIG. 12, the host, which is an external device, can be coupled to the memory system through a plurality of PCIe Gen 3.0 lanes, a PCIe physical layer (PHY) 412, and a PCIe core 414. A controller 400 may include three embedded processors 432A, 432B, 432C, each using a plurality of cores 302A, 302B. Herein, the plurality of cores 302A, 302B or the plurality of embedded processors 432A, 432B, 432C may have a pipeline structure.

The plurality of embedded processors 432A, 432B, 432C may be coupled to an internal DRAM controller (DDR controller) 434 through a processor interconnect. The controller 400 further includes a Low Density Parity-Check (LDPC) sequencer 460, a Direct Memory Access (DMA) engine 420, a scratch pad memory 450 for metadata management, and an NVMe controller 410. Components within the controller 400 may be coupled to a plurality of channels connected to a plurality of memory packages (Flash) 152 through a flash physical layer (NAND flash PHY) 440. The plurality of memory packages 152 may correspond to the plurality of memory chips 252 described in FIG. 12.

According to an embodiment, the NVMe controller 410 included in the controller 400 is a type of storage controller designed for use with solid state drives (SSDs) that use an NVMe interface. The NVMe controller 410 may manage data transfer between the SSD and the computer CPU as well as other functions such as error correction, wear leveling, and power management. The NVMe controller 410 may use a simplified, low-overhead protocol to support fast data transfer rates.

According to an embodiment, the scratch pad memory 450 may be a storage area set by the NVMe controller 410 to temporarily store data. The scratch pad memory 450 may be used to store data waiting to be written to a plurality of memory packages 152. The scratch pad memory 450 can also be used as a buffer to speed up the writing process, typically with a small amount of Dynamic Random Access Memory (DRAM) or Static Random Access Memory (SRAM). When a write command is executed, data may first be written to the scratch pad memory 450 and then transferred to the plurality of memory packages 152 in larger blocks. The scratch pad memory 450 may be used as a temporary memory buffer to help optimize the write performance of the plurality of memory packages 152. The scratch pad memory 450 may serve as intermediate storage of data before the data is written to non-volatile memory cells.

The Direct Memory Access (DMA) engine 420 included in the controller 400 is a component that transfers data between the NVMe controller 410 and a host memory in the host system without involving a host's processor. The DMA engine 420 can support the NVMe controller 410 to directly read or write data from or to the host memory without intervention of the host's processor. According to an embodiment, the DMA engine 420 may achieve or support high-speed data transfer between a host and an NVMe device, using a DMA descriptor that includes information regarding data transfer such as a buffer address, a transfer length, and other control information.

The LDPC sequencer 460 in the controller 400 is a component that performs error correction on data stored in the plurality of memory packages 152. Herein, an LDPC code is a type of error correction code commonly used in a NAND flash memory to reduce a bit error rate. The LDPC sequencer 460 may be designed to immediately process encoding and decoding of LDPC codes when reading and writing data from and to the NAND flash memory. According to an embodiment, the LDPC sequencer 460 may divide data into plural blocks, encode each block using an LDPC code, and store the encoded data in the plurality of memory packages 152. Thereafter, when reading the encoded data from the plurality of memory packages 152, the LDPC sequencer 460 can decode the encoded data based on the LDPC code and correct errors that may have occurred during a write or read operation. The LDPC sequencer 460 may correspond to an ECC circuitry included in the controller 210, 160 described in FIGS. 1 and 10.

The controller 210, 160, 400 described in FIGS. 1, 11, and 12 can check a location, a size, etc. of bad blocks occurring or found in the memory device 220, 180, 152. The size of the bad blocks in the memory device 220, 180, 152 might continuously increase or change, so that each of the plurality of memory dies can have a different bad block size. After the bad blocks can be checked, at least one super block including the bad blocks can be used as, or allocated to, an over provisioning (OP) area. However, in this case, a size of the over provisioning area of each of the plurality of memory dies can be different. If the size of the over provisioning area in each of the plurality of memory dies becomes different, performance of an operation (e.g., a random write operation) using the over provisioning area in each of the plurality of memory dies could be different. When the input/output operation performances of the plurality of memory dies become different, overheads of the controller 210, 160, 400 coupled to the plurality of memory dies could increase in a procedure of performing the data input/output operations in parallel by distributing data entries over the plurality of the memory devices. To avoid this issue, the controller 210, 160, 400 can uniformly control or adjust data input/output operation performances of the plurality of memory dies included in the memory device 220, 180, 152. To this end, as described in FIGS. 4 to 10, the controller 210, 160, 400 can adjust the inactive areas in the plurality of memory dies included in the memory device 220, 180, 152 or adjust scheduling related to the data input/output operations performed in the plurality of memory dies included in the memory device 220, 180, 152.

As above described, a memory system according to an embodiment of the present disclosure can reduce scheduling difficulties for parallel processing or distributed processing, which occur due to differences in data input/output performance of plural memory dies. Further, a memory system according to an embodiment of the present disclosure can reduce or avoid performance differences due to differences in bad blocks occurring or found in plural memory dies, and thus allow an external device that is linked with the memory system to expect a uniform level of performance from the memory system.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods or operations of the computer, processor, controller, or other signal processing device, are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, generators, logic, interfaces, decoders, drivers, and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, generators, logic, interfaces, decoders, drivers, and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, generators, logic, interfaces, decoders, drivers, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods or operations of the computer, processor, microprocessor, controller, or other signal processing device, are described in detail, the code or instructions for implementing the operations of the method embodiments may transform the computer, processor, controller, or other signal processing device into a special-purpose processor for performing the methods described herein.

While the embodiments of the present disclosure have been illustrated and described with respect to the specific embodiments, it will be apparent to those skilled in the art in light of the present disclosure that various changes and modifications may be made without departing from the spirit and scope of the disclosure as defined in the following claims. Furthermore, the embodiments may be combined to form additional embodiments.

What is claimed is:

1. A memory system comprising:
a memory device comprising plural memory dies, each memory die comprising plural memory blocks including an active area and an inactive area; and
a controller configured to adjust sums of a bad block size and an inactive area size in the plural memory dies to be equal to each other based on a bad block occurring or found in the plural memory dies.

2. The memory system according to claim 1, wherein the controller is configured to determine an inactive area size of a first memory die according to a bad block size in the first memory die, so that a sum of the inactive area size and the bad block size for the first memory becomes a same as a sum for another memory die.

3. The memory system according to claim 1, wherein the controller is configured to determine, as the inactive area, at least one cell string among a plurality of cell strings included in each of the plurality of memory dies.

4. The memory system according to claim 1, wherein the controller is configured to determine, as the inactive area, memory cells coupled to at least one word line among a plurality of word lines included in each of the plurality of memory dies.

5. The memory system according to claim 1,
wherein the memory device comprises an over provisioning area including at least the inactive area and the bad blocks in each of the plurality of memory dies, and
wherein the controller is configured to determine sizes of the over provisioning areas in the plurality of memory dies to be equal to each other.

6. The memory system according to claim 1, wherein the controller is further configured to adjust data input/output performance of each of the plurality of memory dies to be equal.

7. The memory system according to claim 6, wherein the controller is further configured to determine the data input/output performance based on a random data writing operation performed on each of the plurality of memory dies.

8. The memory system according to claim 2, wherein the controller is further configured to control a throttling level for the first memory die according to the bad block size in the first memory die.

9. The memory system according to claim 2, wherein the controller is further configured to adjust a ratio of host write operations and garbage collection write operations for the first memory die according to the bad block size in the first memory die.

10. A memory system comprising:
a memory device comprising a plurality of memory dies, each memory die comprising a plurality of memory blocks; and
a controller configured to adjust, based on a difference in bad block sizes in the plurality of memory dies, at least one of scheduling of data input/output operations, performed in at least one of the plurality of memory dies, and an inactive area size in each of the plurality of memory dies.

11. The memory system according to claim 10, wherein, when adjusting the scheduling of the data input/output operations, the controller is configured to adjust at least one of throttling levels for at least one of the plurality of memory dies and a ratio of host write operations and garbage collection write operations performed on at least one of the plurality of memory dies.

12. The memory system according to claim 10, wherein the controller is configured to:
determine a first memory die including a greatest number of bad blocks among the plurality of memory dies,
set the first memory die to include no inactive area; and
determine an inactive area size in each of remaining memory dies other than the first memory die among the plurality of memory dies based on a difference in bad block sizes of the first memory die and each of the remaining memory dies.

13. The memory system according to claim 12, wherein the controller is configured to determine, as the inactive area, at least one cell string among a plurality of cell strings in each of the plurality of memory dies.

14. The memory system according to claim 12, wherein the controller is configured to determine, as the inactive area, memory cells coupled to at least one word line among a plurality of word lines in each of the plurality of memory dies.

15. The memory system according to claim 10, wherein the controller is configured to adjust random data write performance of each of the plurality of memory dies to be substantially a same.

16. A memory system comprising:
a memory device comprising a plurality of first memory dies and a plurality of second memory dies; and
a controller coupled to the plurality of first memory dies through a first channel and coupled to the plurality of second memory dies through a second channel,
wherein the controller is configured to:
adjust first inactive area sizes in the plurality of first memory dies based on first bad block sizes in the plurality of first memory dies; and
adjust second inactive area sizes in the plurality of second memory dies based on second bad block sizes occurring or found in the plurality of second memory dies.

17. The memory system according to claim 16, wherein the controller is configured to:
determine, as the first inactive areas, at least one cell string among a plurality of cell strings in at least one of the plurality of first memory dies; and
determine, as the second inactive area, at least one cell string of a plurality of cell strings in at least one of the plurality of second memory dies.

18. The memory system according to claim 16, wherein the controller is configured to:
determine, as the first inactive areas, memory cells coupled to at least one word line among a plurality of word lines in at least one of the plurality of first memory dies; and
determine, as the second inactive areas, memory cells coupled to at least one word line among a plurality of word lines in at least one of the plurality of second memory dies.

19. The memory system according to claim 16, wherein the controller is further configured to adjust scheduling of data input/output operations performed on the plurality of first memory dies and the plurality of second memory dies, based on a difference between a first sum of the first bad block sizes and the first inactive area sizes in the plurality of first memory dies and a second sum of the second bad block sizes and the second inactive area sizes in the plurality of second memory dies.

20. The memory system according to claim 19, wherein the controller is further configured to adjust the scheduling of the data input/output operations by at least one of:
adjusting throttling levels for the plurality of first or second memory dies; and
adjusting a ratio of host write operations and garbage collection write operations performed on the plurality of first or second memory dies.
